(19) United States
(12) Patent Application Publication
(10) Pub. No.: US 2023/0146036 A1
(43) Pub. Date: May 11, 2023

(54) LIBRARY INTERFACE FOR INTERPROCESS COMMUNICATION

(71) Applicant: KYOCERA Document Solutions Inc., Osaka (JP)

(72) Inventor: Olga Dillard, Concord, CA (US)

(21) Appl. No.: 17/524,625

(22) Filed: Nov. 11, 2021

(51) Int. Cl. G06F 9/54

(52) U.S. Cl. CPC G06F 9/546; G06F 2209/541

(57) ABSTRACT

Systems and methods relate generally to interprocess communication. In an example, a method relating generally to interprocess communication is disclosed. In such a method, a first interprocess communication library and a second interprocess communication library is provided each having server and client components configured for client-server communication with one another. A first process domain having a first function and having the first interprocess communication library is provided. A second process domain having a second function and having the second interprocess communication library is provided. A function call for the first function is transformed to a message using a base class. The message is communicated from the first interprocess communication library to the second interprocess communication library. The message is communicated from the second interprocess communication library to the second function.

### FIELD

The following description relates to interprocess communication. More particularly, the following description relates to a library interface for interprocess communication.

### BACKGROUND

Conventionally, an operating system is configured to allow interprocess communication so processes can communicate with each other. This communication may involve an indication that an event occurred or data transfer.

### SUMMARY

In accordance with one or more below described examples, a method relating generally to interprocess communication is disclosed. In such a method, a first interprocess communication library and a second interprocess communication library is provided each having server and client components configured for client-server communication with one another. A first process domain having a first function and having the first interprocess communication library is provided. A second process domain having a second function and having the second interprocess communication library is provided. A function call for the first function is transformed to a message using a base class. The message is communicated from the first interprocess communication library to the second interprocess communication library. The message is communicated from the second interprocess communication library to the second function.

In accordance with one or more below described examples, a system relating generally to interprocess communication is disclosed. In such a system, a memory is configured to store program code. A processor is coupled to the memory, wherein the processor, in response to executing the program code, is configured to initiate operations for implementing an interprocess communication interface, including: providing a first interprocess communication library and a second interprocess communication library each having both server and client components configured for client-server communication with one another; providing a first process domain having a first function and having the first interprocess communication library; providing a second process domain having a second function and having the second interprocess communication library; transforming a function call for the first function to a message using a base class; communicating the message from the first interprocess communication library to the second interprocess communication library; and communicating the message from the second interprocess communication library to the second function.

Other features will be recognized from consideration of the Detailed Description and Claims, which follow.

### BRIEF DESCRIPTION OF THE DRAWINGS

Accompanying drawings show exemplary apparatus(es) and/or method(s). However, the accompanying drawings should not be taken to limit the scope of the claims, but are for explanation and understanding only.

FIG. 1 is a block diagram depicting an example of a single process with two functions of the prior art.

FIG. 2-1 is a block diagram depicting an example of a system with two processes with a library interface for interprocess communication (“IPC”).

FIG. 2-2 is a block class diagram depicting another example of a system with two processes with a library interface for IPC.

FIG. 2-3 is a block-sequence diagram depicting an example of a sequence flow.

FIG. 3-1 is a flow diagram depicting an example of an IPC flow.

FIG. 3-2 is a flow diagram depicting an example of another IPC flow.

FIG. 4 is a pictorial diagram depicting an example of a network.

FIG. 5 is block diagram depicting an example of a portable communication device.

FIG. 6 is a block diagram depicting an example of a multi-function printer (MFP).

FIG. 7 is a block diagram depicting an example of a computer system.

### DETAILED DESCRIPTION

In the following description, numerous specific details are set forth to provide a more thorough description of the specific examples described herein. It should be apparent, however, to one skilled in the art, that one or more other examples and/or variations of these examples may be practiced without all the specific details given below. In other instances, well known features have not been described in detail so as not to obscure the description of the examples herein. For ease of illustration, the same number labels are used in different diagrams to refer to the same items, however, in alternative examples the items may be different.

Exemplary apparatus(es) and/or method(s) are described herein. It should be understood that the word “exemplary” is used herein to mean “serving as an example, instance, or illustration.” Any example or feature described herein as “exemplary” is not necessarily to be construed as preferred or advantageous over other examples or features.

Before describing the examples illustratively depicted in the several figures, a general introduction is provided to further understanding.

As previously indicated, interprocess communication is provided by operating systems. However, coding and debugging such hosted interprocess communication can be tedious.

In one or more below described examples, a less tedious form of interprocess communication is disclosed. Furthermore, because a conventional process may be broken up into two processes, domains of such processes may be different. For example, one domain may be an open source domain and another domain may be a closed source domain. As described below in additional detail, an interprocess communication interface, which may be uni- or bi-directional, may be provided by having a first interprocess communication library in one process domain and a second interprocess communication library in another process domain, where each such library has at least one set of server and/or client components configured for client-server communication with one another.

With the above general understanding borne in mind, various configurations for systems, and methods therefor, with interprocess communication components are generally described below for forming an interprocess communication interface.

Reference will now be made in detail to examples which are illustrated in the accompanying drawings. In the following detailed description, numerous specific details are set forth in order to provide a thorough understanding of the following described implementation examples. It should be apparent, however, to one skilled in the art, that the implementation examples described below may be practiced without all the specific details given below. Moreover, the example implementations are not intended to be exhaustive or to limit scope of this disclosure to the precise forms disclosed, and modifications and variations are possible in light of the following teachings or may be acquired from practicing one or more of the teachings hereof. The implementation examples were chosen and described in order to best explain principles and practical applications of the teachings hereof to enable others skilled in the art to utilize one or more of such teachings in various implementation examples and with various modifications as are suited to the particular use contemplated. In other instances, well-known methods, procedures, components, circuits, and/or networks have not been described in detail so as not to unnecessarily obscure the described implementation examples.

For purposes of explanation, specific nomenclature is set forth to provide a thorough understanding of the various concepts disclosed herein. However, the terminology used herein is for the purpose of describing particular examples only and is not intended to be limiting. As used herein, the singular forms “a”, “an” and “the” are intended to include the plural forms as well, unless the context clearly indicates otherwise. As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context. It will also be understood that the term “and/or” as used herein refers to and encompasses any and all possible combinations of one or more of the associated listed items. It will be further understood that the terms “includes” and/or “including,” when used in this specification, specify the presence of stated features, integers, steps, operations, elements, and/or components, but do not preclude the presence or addition of one or more other features, integers, steps, operations, elements, components, and/or groups thereof. It will also be understood that, although the terms first, second, etc., may be used herein to describe various elements, these elements should not be limited by these terms, as these terms are only used to distinguish one element from another.

Some portions of the detailed descriptions that follow are presented in terms of algorithms and symbolic representations of operations on data bits, including within a register or a memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those involving physical manipulations of physical quantities. Usually, though not necessarily, these quantities take the form of optical, electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers or memories into other data similarly represented as physical quantities within the computer system memories or registers or other such information storage, transmission or display devices.

Concepts described herein may be embodied as apparatus, method, system, or computer program product. Accordingly, one or more of such implementation examples may take the form of an entirely hardware implementation example, an entirely software implementation example (including firmware, resident software, and micro-code, among others) or an implementation example combining software and hardware, and for clarity any and all of these implementation examples may generally be referred to herein as a “circuit,” “module,” “system,” or other suitable terms. Furthermore, such implementation examples may be of the form of a computer program product on a computer-usable storage medium having computer-usable program code in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (“RAM”), a read-only memory (“ROM”), an erasable programmable read-only memory (“EPROM” or Flash memory), an optical fiber, a portable compact disc read-only memory (“CD-ROM”), an optical storage device, a transmission media such as those supporting the Internet or an intranet, or a magnetic storage device. The computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, radio frequency (“RF”) or other means. For purposes of clarity by way of example and not limitation, the latter types of media are generally referred to as transitory signal bearing media, and the former types of media are generally referred to as non-transitory signal bearing media.

Computer program code for carrying out operations in accordance with concepts described herein may be written in an object-oriented programming language such as Java, Smalltalk, C++ or the like. However, the computer program code for carrying out such operations may be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (“LAN”) or a wide area network (“WAN”), or the connection may be made to an external computer (for example, through the Internet using an Internet Service Provider).

Systems and methods described herein may relate to an apparatus for performing the operations associated therewith. This apparatus may be specially constructed for the purposes identified, or it may include a general-purpose computer selectively activated or reconfigured by a computer program stored in the computer.

Notwithstanding, the algorithms and displays presented herein are not inherently related to any particular computer or other apparatus. Various general-purpose systems may be used with programs in accordance with the teachings herein, or it may prove convenient to construct a more specialized apparatus to perform the operations. In addition, even if the following description is with reference to a programming language, it should be appreciated that any of a variety of programming languages may be used to implement the teachings as described herein.

One or more examples are described below with reference to flowchart illustrations and/or block diagrams of methods, apparatus (including systems) and computer program products. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowcharts and block diagrams in the Figures illustrate the architecture, functionality, and operation of possible implementations of apparatuses (including systems), methods and computer program products according to various implementation examples. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

It should be understood that although the flow charts provided herein show a specific order of operations, it is understood that the order of these operations may differ from what is depicted. Also, two or more operations may be performed concurrently or with partial concurrence. Such variation will depend on the software and hardware systems chosen and on designer choice. It is understood that all such variations are within the scope of the disclosure. Likewise, software and web implementations may be accomplished with standard programming techniques with rule-based logic and other logic to accomplish the various database searching operations, correlation operations, comparison operations and decision operations. It should also be understood that the word “component” as used herein is intended to encompass implementations using one or more lines of software code, and/or hardware implementations, and/or equipment for receiving manual inputs.

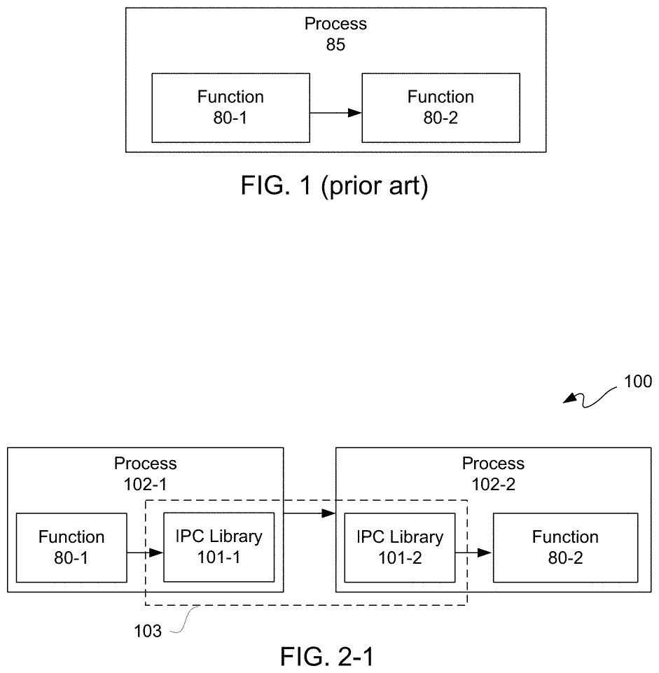

FIG. 1 is a block diagram depicting an example of a single process with two functions of the prior art. More particularly, in this example, a single process 85 includes a first function 80-1 and a second function 80-2. Even though inter-process communication (IPC) is known, such in Unix or other operating system, when a single process 85 is separated into two processes, for any of a variety of reasons, coding and debugging for IPC can be problematic.

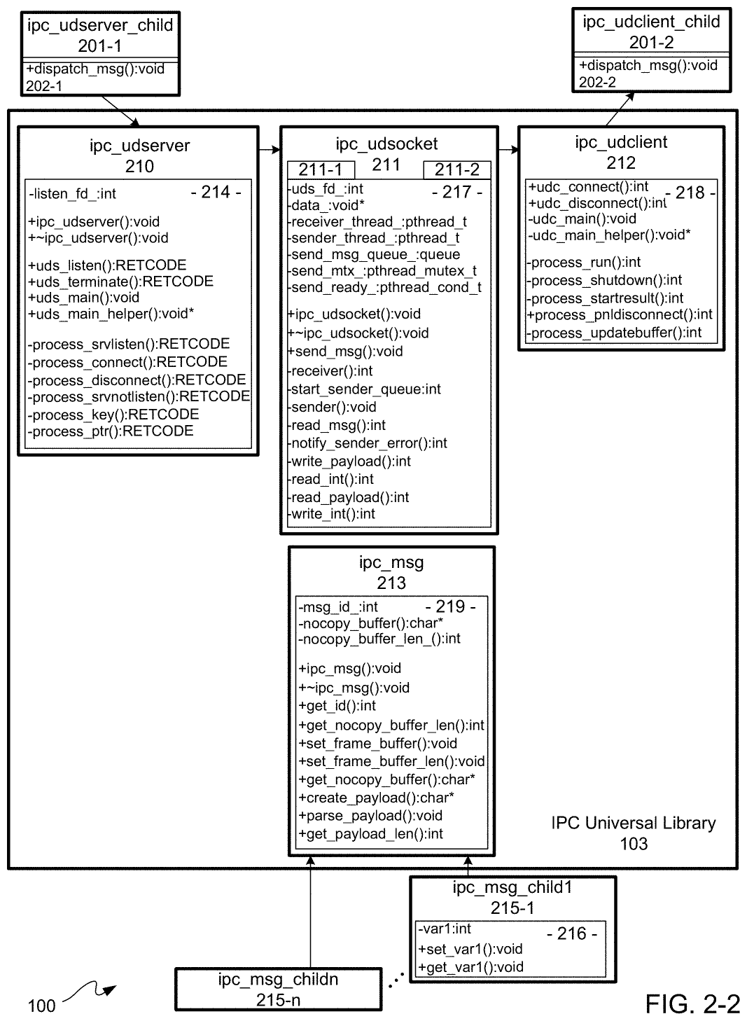

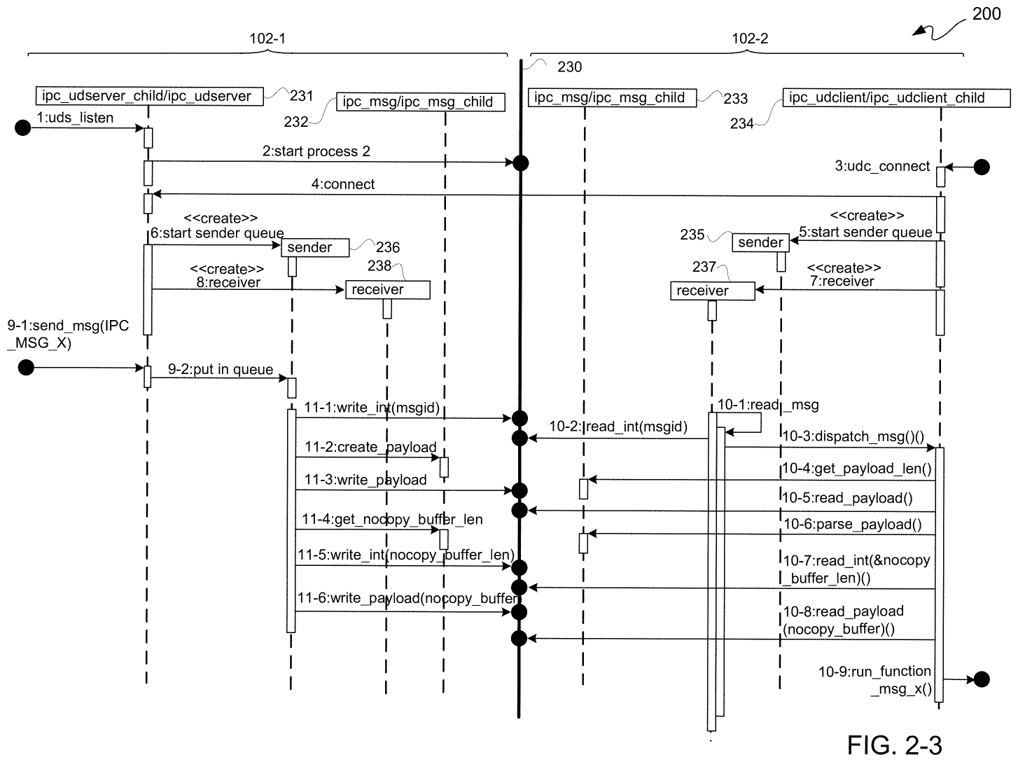

FIG. 2-1 is a block diagram depicting an example of a system 100 with two processes with a library interface for IPC. More particularly, in this example, process 102-1 includes a function 80-1 and an IPC library 101-1, and process 102-2 includes a function 80-2 and an IPC library 101-2. Though communication is generally shown in one direction as indicated by direction of arrows in this example, in another example such communication may be bi-directional.

IPC library 101-1 and IPC library 101-2 in combination provide what is termed herein as a “universal library” or “library” 103 for IPC. The term “universal” is generally used to indicate that IPC library 103 may generally be implemented with any of a variety of computer coding languages and in any of a variety of operating systems, for purposes of clarity by way of example and not limitation, IPC library 103 is described for C++ in a Unix operating system environment.

Having an IPC library 103 spanning all communication between processes 102-1 and 102-2 may be used to help to organize IPC. Along those lines, a C++ programmer can take “universal” IPC library 103 and create derived classes for each function call between processes 102-1 and 102-2 based on a base class provided by IPC library 103, or more particularly IPC library 101-1.

This creation of derived classes from such a base class may involve use of an application programming interface or API of IPC library 103, and such creation may be without regard to IPC communication. In other words, a programmer does not need to have an intimate knowledge of IPC for programming; rather, by use of an API to IPC library 103 a programmer may avoid complexities associated with coding and debugging an IPC interface. As described below in additional detail, IPC library 103 may transform function calls into messages using a base class, such as for example a single base class. Along those lines, IPC library 103 may be code agnostic, namely generally “universal” with respect to any of a variety of software coding languages.

For example, function 80-1 may be proprietary/closed source code and function 80-1 may be public/open sourced code. With use of IPC library 103, function 80-1 may be retained in private without exposure while using function 80-2. This may be useful for security or other reasons.

FIG. 2-2 is a block class diagram depicting another example of a system 100 with two processes with a library interface for IPC. More particularly, in this example there is an ipc_udserver_child or IPC_udserver_child 201-1, such as a server for message transfer. With simultaneous reference to FIGS. 2-1 and 2-2, system 100 of FIG. 2-2 is further described.

In this example, IPC_udserver_child 202-1 is a Unix domain socket server; however, in another example another type of udserver may be used. Even more particularly, in this example, IPC library 103 uses a Unix domain socket or an IPC socket for IPC, and IPC library 103 contains both server and client components, which respectively are server and client for each Unix domain socket. In other words, IPC libraries 101-1 and 101-2 may both have the same operations of sender and receiver, so both processes 102-1 and 102-2 can send and receive messages generally at the same time. However, in another example a different IPC socket providing a data communications “endpoint” for data exchanges, such as messages, between processes 102-1 and 102-2, may be used. In this example, both processes 102-1 and 102-2 may be executing on a same host operating system, which in this example is Unix. Furthermore, sockets are used as endpoints of IPC; however, intra-process communication may be to and from endpoints. Furthermore, in another example IPC library 101-1 for example may have only server components and IPC library 101-2 for example may have only client components for uni-directional server to client traffic.

IPC_server_child 201-1 may be a sender/server and a receiver/child. IPC_server_child 201-1 may be configured to dispatch messages with a dispatch function call 202-1. IPC_server_child 201-1 may be of process 102-1.

Likewise, IPC_client_child, or ipc_udclient_child as in this example, 201-2 may be a sender/server and a receiver/child. IPC_client_child 201-2 may be configured to dispatch messages with a dispatch function call 202-2. IPC_client_child 201-2 may be of process 102-2.

To recapitulate in pseudocode, process 102-1 (“Process#1”) and process 102-2 (“Process#2”), respectively a Unix domain socket server and client, performs as follows:

```
Process#1
  call ipc_udserver_child::uds_listen( )
  start Process#2
  wait until flag set that Process2(udclient) connected to udserver
Process#2
  call ipc_udclient_child::udc_connect( )
```

To call a function from a different process, either Process#1 or Process#2 in this example, a domain socket server creates a message object, set arguments and calls a send message (“send_msg( )”) function, as follows:

ipc_udclient_child::send_msg(msg)
ipc_server_child::send_msg(msg)

In this example, described is how Process#1 calls a function from Process#2 using IPC universal library 103; however, the opposite direction of function calling, namely by Process#2 from/to Process#1, may likewise be implemented, and so same description though in the opposite direction is not repeated for purposes of clarity and not limitation.

IPC_udserver_client 201-1 and 202-1 are in IPC with one another via IPC library 103. In this example, only one direction of communication from IPC_udserver_client 201-1 to 202-1 is illustratively depicted, as the reverse direction follows from such description. Furthermore, ipc_udserver 210, ipc_udsocket 211, and ipc udclient 212 may each be in IPC library 101-1 and IPC library 101-2, as each such library may have a complete set of server, socket and client for bi-directional communication. However, again for purposes of clarity by way of example and not limitation, one-way communication is described.

A message, such as for example ipc_message or ipc_msg 213, may be sent or dispatched from IPC_udserver_child 201-1 of Process 102-1 to ipc_udserver 210 also of such process. Examples of some possible server components 214 of a udserver are illustratively depicted. However, these and/or other udserver components may be used in other examples.

Such an ipc_message 213 may be processed by ipc_udserver 210 for handoff to ipc_udsocket 211. Even though a single ipc_udsocket 211 is illustratively shown, there may be two of such instances of such ipc_udsocket 211 as generally indicated by boxes 211-1 and 211-2. In this example, ipc_udsocket 211-1 is of process 102-1, and ipc_udsocket 211-2 is of process 102-2. Collectively, these sockets form an interface or boundary between processes 102-1 and 102-2. Examples of possible socket components 217 of a udsocket are illustratively depicted. However, these and/or other udsocket components may be used in other examples.

Such an ipc_message 213 may be passed from ipc_udsocket 211-1 to ipc_udsocket 211-2 for IPC from a domain of process 102-1 to a domain of process 102-2. From ipc_udsocket 211-2, ipc_message 213 may be handed off to ipc_udclient 212 of a domain of process 102-2. Examples of some possible client components 218 of a udclient are illustratively depicted. However, these and/or other udclient components may be used in other examples. After processing by ipc_udclient 212, ipc_message 213 may be handed off to ipc_udclient_child 201-2.

Each IPC library 101-1 and 101-2 may include one or more server components 214, one or more socket components 217, and one or more client components 218. Moreover, each ipc_message 213 may include one or more message components. Examples of some possible message components 219 of an ipc_message 213 are illustratively depicted. However, these and/or other ipc message components may be used in other examples. After processing by ipc_udclient 212, ipc_message 213 may be handed off to ipc_udclient_child 201-2.

Furthermore, there may be other ipc_messages for other children/clients. For example, there may be ipc_msg_child1 215-1 through ipc_msg_childn 215n provided for communication to udclients 1 through n via a single IPC library 103. Examples of some possible other message components 216 of an ipc_msg_child 215-1 are illustratively depicted. However, these and/or other ipc message child components may be used in other examples.

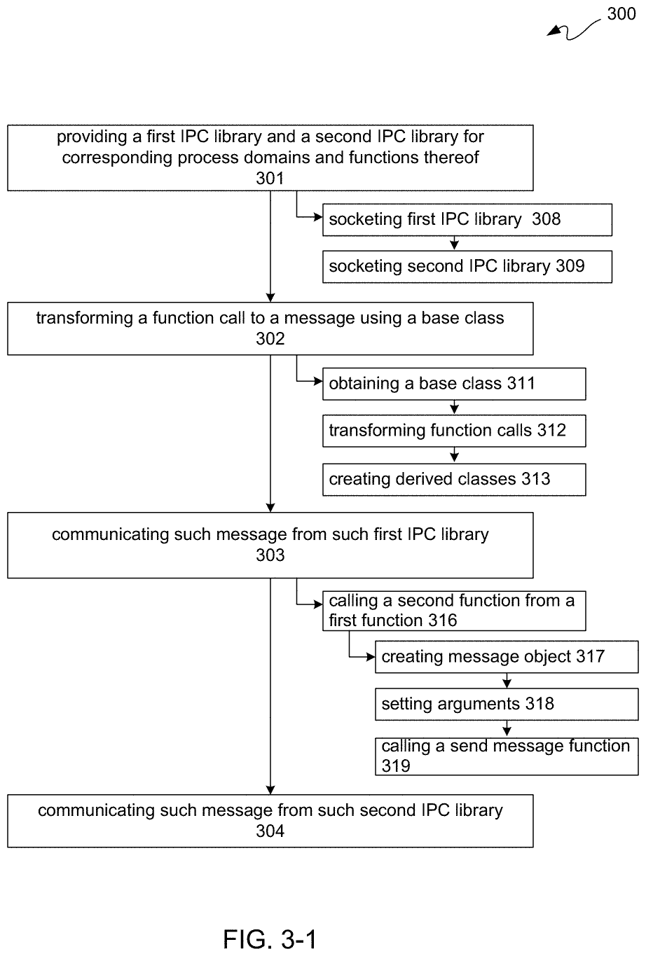

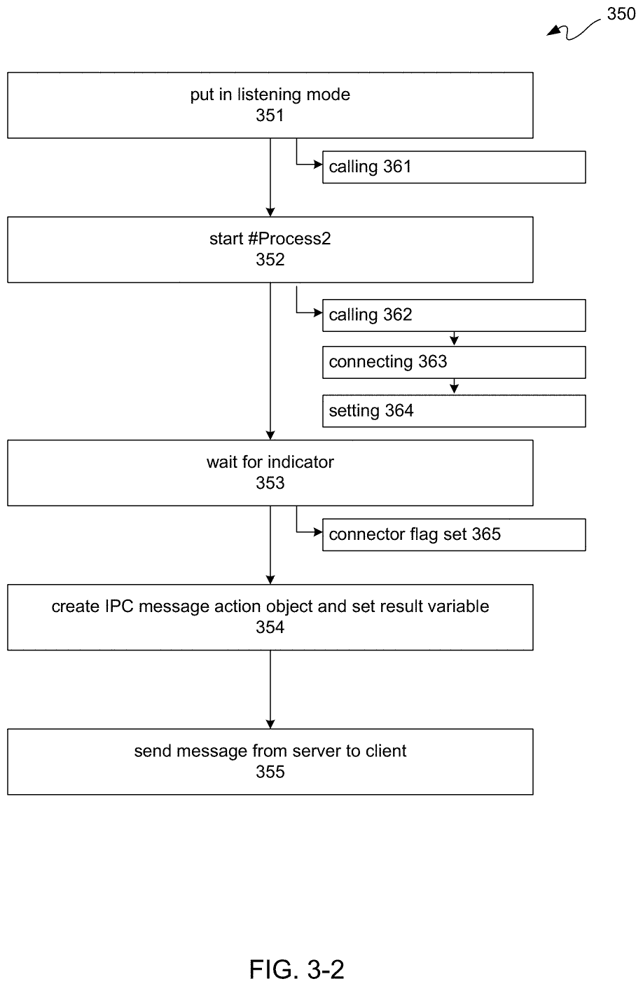

FIG. 2-3 is a block-sequence diagram depicting an example of a sequence flow 200. For clarity, ipc_udserver_child/ipc_udserver domain 231, ipc_msg/ipc_msg_child domain 232, ipc_msg/ipc_msg_child domain 233, and ipc_udclient/ipc_udclient_child domain 234 domains or operations are delineated with corresponding dashed lines associated with each of such boxes. A thick black vertical line, depicts a process 102-1 to process 102-2 interface or boundary 230. Domains 231 and 232 are of process 102-1, and domains 233 and 234 are of process 102-2. Though a sequence of operations 1 through 16, inclusive, may be performed in the example order, it will be understood that some operations may be performed at generally the same time as other operations, and so such sequence is merely for illustrative purposes for clarity by way of example and not limitation.

In this example, such sequence flow 200 starts with a 1:uds_listen in domain 231. From a listen, 2:start process 2 is initiated for interface 230.

In domain 234, a 3:udc_connect is initiated, and such call may result in a 4:connect across interface 230 from domain 234 to domain 231. At 5:start sender queue a sender 235 in a domain of process 102-2 may be created.

In domain 231, a 6:start sender queue may be created for a sender 236. Meanwhile, in process 102-2 domain a receiver 237 function may be created by a function call 7:receiver. Similarly, in process 102-1 domain a receiver 238 may be created by a function call 8:receiver.

In domain 231, at 9-1:send_msg an IPC message X may be sent, and at 9-2 such message may be put in a queue. In domain 233, at 10-1:read_msg such sent message may be called to be read. At 10-2:read_int an integer of a message ID may be read.

In domain 234, such message may be dispatched, payload length obtained, payload read, payload parsed, buffer length integer read, payload read, and a function identified by message X run respectively at 10-3:dispatch_msg( )( ), 10-4:get_payload_len( ), 10-5:read_payload( ), 10-6:parse_payload( ), 10-7:read_int(&nocopy_buffer_len)( ), 10-8:read_payload(nocopy_buffer)( ), and 10-9:run_function_msg_x( ).

Correspondingly, in domain 232, such message ID may be written at 11-1:write_int(msgid); such payload may be created at 11-2:create_payload; such payload may be written at 11-3:write_payload; a buffer length may be obtained at 11-4:get_nocopy_buffer_len; an integer value of the buffer length may be written at 11-5:write_int(nocopy_buffer_len); and payload may be written to such buffer at 11-6:write_payload(nocopy_buffer).

FIG. 3-1 is a flow diagram depicting an example of an IPC flow 300. IPC flow 300 is further described with simultaneous reference to FIGS. 2-1 through 3-1.

At operation 301, a first IPC library and a second IPC library each having both server and client components configured for client-server communication with one another may be provided. For example, IPC libraries 101-1 and 101-2 may be provided as previously described. As part of operation 301, a first process domain having a first function and having such first IPC library may be provided. Further as part of operation 301, a second process domain having a second function and having such second IPC library may be provided. For example, processes or process domains 10-2-1 and 102-2 may be provided respectively as previously described.

At operation 308, such first IPC library may be socketed in a first addressable location in a first process domain. At operation 309, such a second IPC library may be socketed in a second addressable location in a second process domain.

At operation 302, a function call for such first function may be transformed into a message using a base class. Such transformation may be as previously described herein for example. Such first function may be of a closed-source software app or code listing, and such second function may be of an open-source software app or code listing.

At operation 302, one or more of operations 311 through 313 may be performed. At operation 311, a base class of an IPC library may be obtained. At operation 312, function calls may be transformed into corresponding messages using such base class obtained.

At operation 313, one or more derived classes for each function call between first process domain and second process domain may be created with a base class of an IPC library using an application programming interface (API) of or for such IPC library associated therewith. Such creation may be performed independently of use of an IPC interface between IPC libraries.

At operation 303, such message may be communicated from such first IPC library to such second IPC library. Such communication may be as previously described herein for example. For example, at operation 316 of operation 303, a second function of a second process domain may be called from a first process domain as previously described. Such calling may involve one or more of operations 317 through 319.

At operation 317, a message object may be created. At operation 318, arguments may be set, and at operation 319, a send message function may be called.

At operation 304, such message from operation 303 may be communicated from such second IPC library to such second function. For example, such message may be communicated between process domains 10-2-1 and 102-2 as previously described for instruction of such a second function.

FIG. 3-2 is a flow diagram depicting an example of another IPC flow 350. IPC flow 300 is further described with simultaneous reference to FIGS. 2-1 through 3-2.

In an above example, a first process domain is a socketed server (“server”) for an operating system. At operation 351, such a server may be put in a listing mode. For example, ipc_udserver_child:uds_listen( ) may be used. Along those lines, a server-child process domain of a first IPC library may be called at operation 361. Such a server may be put in a listening mode after calling a server-child process domain of a first IPC library.

At operation 352, with such server in a listing mode, a second process or a second process domain may be started or activated. A second process domain may be a socketed client (“client”) for an operating system. Starting such a second process domain at operation 352 may include operations 362 through 364.

At operation 362, a client-child process domain of a second IPC library may be called. At operation 363, such client may be connected to such server via an IPC library interface. At operation 364, an indicator may be set to indicate that such client is connected to such server.

At operation 353, IPC flow 350 may wait unit such a set indicator indicates such second process domain is connected to such server. For example, such wait may be until an ipc_udclient connected flag is set at operation 365 of operation 353.

At operation 354, a message action object for interprocess domain communication may be created and a result variable may be set. For example create ipc_msg_action*msg=new ipc_msg_action (MSG_ACTION, (int)*result).

At operation 355, a message, or more particularly a message action object, may be sent from such socketed server to such socketed client. Such a message may represent a function, or more particularly a function call for calling and/or instructing a function, such as a second function of a second process domain in the above example. For example, ipc_udserver_child->send_msg(msg).

Below are some pseudocode examples for purposes of clarity and not limitation.

Example 1, for integration of an IPC library, an update IPC_MSG_ID enum, add id for each function call may be used. Next, derived classes may be created from an ipc_msg class for each function call Each argument for this function call could be added as private variable to a new derived class. If a function call must return a value, a developer may create an extra message to send back. A developer may implement functions parse_payload( ), create_payload( ) and get_payload_len( ). These functions are similar, as may be seen in additional detail in Example 3 below. Derived classes may be created from ipc_udclient and ipc_udserver, and a dispatch_msg( ) function may be implemented in each derived class, as indicated in additional detail in Example 4 below.

Example 2 is for an IPC_MSG_ID enum as follows:

```
  enum IPC_MSG_ID{
    IPC_MSG_1, - to use IPC library add message id for each function call
that needs to be executed in the different process
    IPC_MSG_MAX
  };
```

Example 3 is of an ipc_msg child class as follows. For example, a function void action(int result), a developer could create the following class:

```
class ipc_msg_action: public ipc_msg
{
public:
  // Constructor and Destructor
  ipc_msg_action(unsigned int id, int result): ipc_msg(id) {result_ = result;}
  ~ipc_msg_action( ) { };
  virtual char* create_payload(unsigned int *len);
  virtual unsigned int get_payload_len( );
  virtual void parse_payload(char *buffer);
  int get_result( ) {return result_;}
private:
  // Private Variables
  int result_; <− argument for function call
}; //class prs_mng_rfb_msg_startresult
unsigned int ipc_msg_action::get_payload_len( )
{
  unsigned int I = 0;
  I = sizeof(int); − payload is only one integer argument − result
  return I;
}
char* ipc_msg_action::create_payload(unsigned int *len)
{
  unsigned int I = get_payload_len( );
  char *payload_ = new char[I]; −allocate payload memory −it is 1 integer for this
example
  if (payload_ == NULL) {
    //error, nothing to send
      I = 0;
      return NULL;
  } else { }
  //start fill it in
  char *ptr = payload_;
  //result
  unsigned int tempi = htonl(result_); − copy “result” into allocated memory
  char *temp = (char *) &tempi;
  memcpy(ptr, temp, sizeof(unsigned int));
  ptr = ptr + sizeof(unsigned int);
  *len = I;
  return payload_; − return payload memory
}
void ipc_msg_action::parse_payload(char *buffer)
{
  int tempi = 0;
  char *temp = (char *)&tempi;
  char *ptr = buffer; buffer has only 1 integer “result”
  memcpy(temp, ptr, sizeof(int));
  result_ = ntohl(tempi); - saving argument in private variable of class
}
```

Example 4 is of a flow for a dispatch_msg( ), as follows:

```
int ipc_udclient_child::dispatch_msg(int msgid)
{
  int ret = OK;
    switch (msgid) {
    case IPC_MSG_1:
      ret = process_msg1( );
      break;
    case IPC_MSG_2:
      ret = process_msg2( );
      break;
    default:
      break;
  }
  return ret;
}
```

A process_msg1( ) function may have the following example structure, following Example 3, as follows: (1) create empty ipc_msg_action object ipc_msg_action*msg=new ipc_msg_action (MSG_ID_1, 0); (2) int len=msg->get_payload_len( ); (3) allocate buffer and read payload in such buffer: ret=read_payload(buffer, len); where this function is inherited from a library class; (4) parse buffer into ipc_msg_child1 object: msg->parse_payload(buffer); (5) read arguments, result=ipc_msg_action->get_result( ); and (6) process functionality using argument, ret=action(result).

In the above example, a component, namely a remote panel server, was split into two processes, and messages, instead of functions, were sent between such processes over an IPC library interface. This allows for example an open source process to run in one process domain and closed or proprietary source process to run in another process domain, where such processes can communicate with one another via an IPC library interface agnostic with respect to particular coding type, namely “universal” as previously described. So, for example, printer controller code may be in a proprietary process domain and communicate via an IPC library interface with an app in an open source (or closed source) process domain. So, the example wraps C++ classes into a library format for a printer controller, but such code may be separated into two processes for any application, not just printers.

Because one or more of the examples described herein may be implemented using an information processing system, a detailed description of examples of each of a network (such as for a Cloud-based SaaS implementation), a computing system, a mobile device, and an MFP is provided. However, it should be understood that other configurations of one or more of these examples may benefit from the technology described herein.

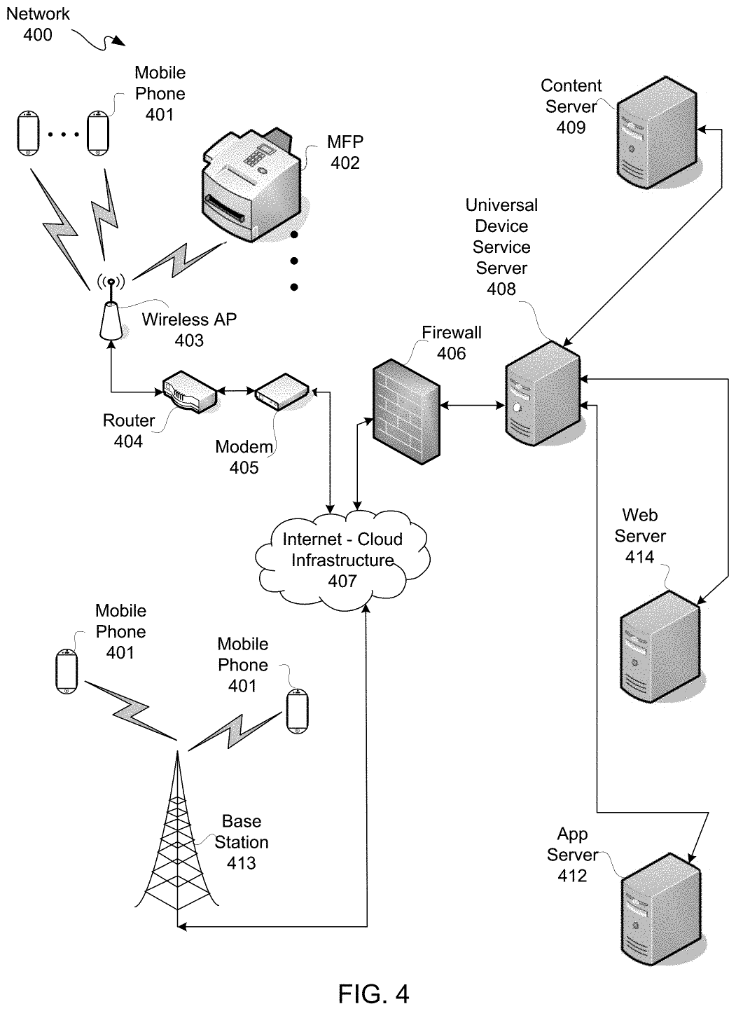

FIG. 4 is a pictorial diagram depicting an example of a network 400, which may be used to provide a SaaS platform for hosting a service or micro service for use by a user device, as described herein. Along those lines, network 400 may include one or more mobile phones, pads/tablets, notebooks, and/or other web-usable devices 401 in wired and/or wireless communication with a wired and/or wireless access point (“AP”) 403 connected to or of a wireless router. Furthermore, one or more of such web-usable wireless devices 401 may be in wireless communication with a base station 413.

Additionally, a desktop computer and/or a printing device, such as for example one or more multi-function printer (“MFPs”) 402, each of which may be web-usable devices, may be in wireless and/or wired communication to and from router 404. An MFP 402 may include at least one plasma head as previously described herein.

Wireless AP 403 may be connected for communication with a router 404, which in turn may be connected to a modem 405. Modem 405 and base station 413 may be in communication with an Internet-Cloud infrastructure 407, which may include public and/or private networks.

A firewall 406 may be in communication with such an Internet-Cloud infrastructure 407. Firewall 406 may be in communication with a universal device service server 408. Universal device service server 408 may be in communication with a content server 409, a web server 414, and/or an app server 412. App server 412, as well as a network 400, may be used for downloading an app or one or more components thereof for accessing and using a service or a micro service as described herein.

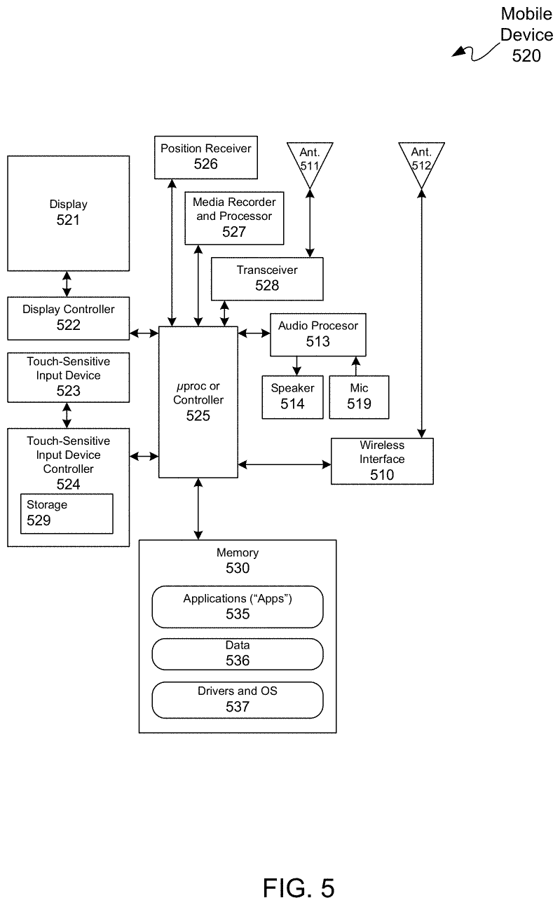

FIG. 5 is block diagram depicting an example of a portable communication device (“mobile device”) 520. Mobile device 520 may be an example of a mobile device used to instruct a printing device.

Mobile device 520 may include a wireless interface 510, an antenna 511, an antenna 512, an audio processor 513, a speaker 514, and a microphone (“mic”) 519, a display 521, a display controller 522, a touch-sensitive input device 523, a touch-sensitive input device controller 524, a microprocessor or microcontroller 525, a position receiver 526, a media recorder 527, a cell transceiver 528, and a memory or memories (“memory”) 530.

Microprocessor or microcontroller 525 may be programmed to control overall operation of mobile device 520. Microprocessor or microcontroller 525 may include a commercially available or custom microprocessor or microcontroller.

Memory 530 may be interconnected for communication with microprocessor or microcontroller 525 for storing programs and data used by mobile device 520. Memory 530 generally represents an overall hierarchy of memory devices containing software and data used to implement functions of mobile device 520. Data and programs or apps as described hereinabove may be stored in memory 530.

Memory 530 may include, for example, RAM or other volatile solid-state memory, flash or other non-volatile solid-state memory, a magnetic storage medium such as a hard disk drive, a removable storage media, or other suitable storage means. In addition to handling voice communications, mobile device 520 may be configured to transmit, receive and process data, such as Web data communicated to and from a Web server, text messages (also known as short message service or SMS), electronic mail messages, multimedia messages (also known as MMS), image files, video files, audio files, ring tones, streaming audio, streaming video, data feeds (e.g., podcasts), and so forth.

In this example, memory 530 stores drivers, such as I/O device drivers, and operating system programs (“OS”) 537. Memory 530 stores application programs (“apps”) 535 and data 536. Data may include application program data.

I/O device drivers may include software routines accessed through microprocessor or microcontroller 525 or by an OS stored in memory 530. Apps, to communicate with devices such as the touch-sensitive input device 523 and keys and other user interface objects adaptively displayed on a display 521, may use one or more of such drivers.

Mobile device 520, such as a mobile or cell phone, includes a display 521. Display 521 may be operatively coupled to and controlled by a display controller 522, which may be a suitable microcontroller or microprocessor programmed with a driver for operating display 521.

Touch-sensitive input device 523 may be operatively coupled to and controlled by a touch-sensitive input device controller 524, which may be a suitable microcontroller or microprocessor. Along those lines, touching activity input via touch-sensitive input device 523 may be communicated to touch-sensitive input device controller 524. Touch-sensitive input device controller 524 may optionally include local storage 529.

Touch-sensitive input device controller 524 may be programmed with a driver or application program interface (“API”) for apps 535. An app may be associated with a service, as previously described herein, for use of a SaaS. One or more aspects of above-described apps may operate in a foreground or background mode.

Microprocessor or microcontroller 525 may be programmed to interface directly touch-sensitive input device 523 or through touch-sensitive input device controller 524. Microprocessor or microcontroller 525 may be programmed or otherwise configured to interface with one or more other interface device(s) of mobile device 520. Microprocessor or microcontroller 525 may be interconnected for interfacing with a transmitter/receiver (“transceiver”) 528, audio processing circuitry, such as an audio processor 513, and a position receiver 526, such as a global positioning system (“GPS”) receiver. An antenna 511 may be coupled to transceiver 528 for bi-directional communication, such as cellular and/or satellite communication.

Mobile device 520 may include a media recorder and processor 527, such as a still camera, a video camera, an audio recorder, or the like, to capture digital pictures, audio and/or video. Microprocessor or microcontroller 525 may be interconnected for interfacing with media recorder and processor 527. Image, audio and/or video files corresponding to the pictures, songs and/or video may be stored in memory 530 as data 536.

Mobile device 520 may include an audio processor 513 for processing audio signals, such as for example audio information transmitted by and received from transceiver 528. Microprocessor or microcontroller 525 may be interconnected for interfacing with audio processor 513. Coupled to audio processor 513 may be one or more speakers 514 and one or more microphones 519, for projecting and receiving sound, including without limitation recording sound, via mobile device 520. Audio data may be passed to audio processor 513 for playback. Audio data may include, for example, audio data from an audio file stored in memory 530 as data 536 and retrieved by microprocessor or microcontroller 525. Audio processor 513 may include buffers, decoders, amplifiers and the like.

Mobile device 520 may include one or more local wireless interfaces 510, such as a WIFI interface, an infrared transceiver, and/or an RF adapter. Wireless interface 510 may provide a Bluetooth adapter, a WLAN adapter, an Ultra-Wideband (“UWB”) adapter, and/or the like. Wireless interface 510 may be interconnected to an antenna 512 for communication. As is known, a wireless interface 510 may be used with an accessory, such as for example a hands-free adapter and/or a headset. For example, audible output sound corresponding to audio data may be transferred from mobile device 520 to an adapter, another mobile radio terminal, a computer, or another electronic device. In another example, wireless interface 510 may be for communication within a cellular network or another Wireless Wide-Area Network (WWAN).

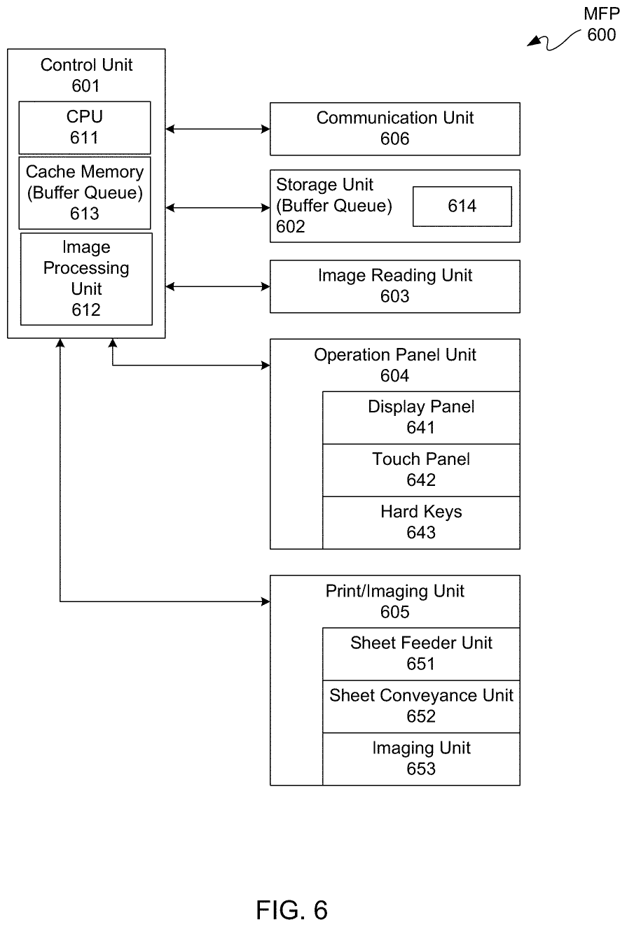

FIG. 6 is a block diagram depicting an example of a multi-function printer MFP 600. MFP 600 is provided for purposes of clarity by way of non-limiting example. MFP 600 is an example of an information processing system such as for handling a printer job.

MFP 600 includes a control unit 601, a storage unit 602, an image reading unit 603, an operation panel unit 604, a print/imaging unit 605, and a communication unit 606. Communication unit 606 may be coupled to a network for communication with other peripherals, mobile devices, computers, servers, and/or other electronic devices.

Control unit 601 may include a CPU 611, an image processing unit 612, and cache memory 613. Control unit 601 may be included with or separate from other components of MFP 600. Storage unit 602 may include ROM, RAM, and large capacity storage memory, such as for example an HDD or an SSD. Storage unit 602 may store various types of data and control programs, including without limitation a printer imaging pipeline program 614. A buffer queue may be located in cache memory 613 or storage unit 602.

Operation panel unit 604 may include a display panel 641, a touch panel 642, and hard keys 643. Print/imaging unit 605 may include a sheet feeder unit 651, a sheet conveyance unit 652, and an imaging unit 653.

Generally, for example, for an MFP a copy image processing unit, a scanner image processing unit, and a printer image processing unit may all be coupled to respective direct memory access controllers for communication with a memory controller for communication with a memory. Many known details regarding MFP 600 are not described for purposes of clarity and not limitation.

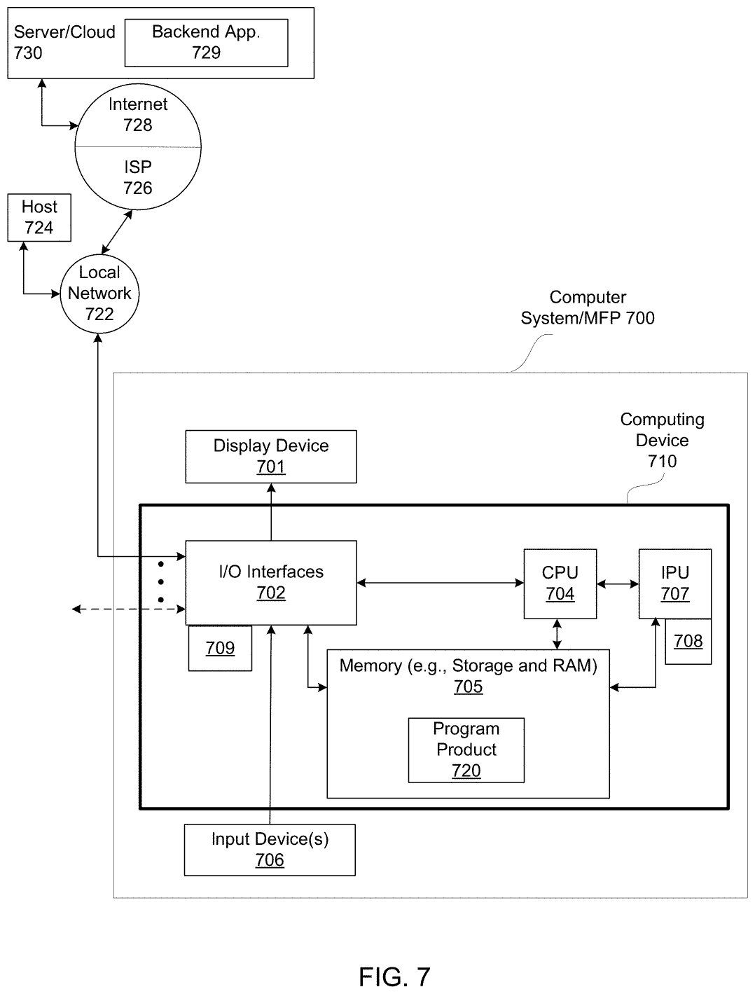

FIG. 7 is a block diagram depicting an example of a computer system or MFP 700 (“computer system”) upon which one or more aspects described herein may be implemented. Computer system 700 may include a programmed computing device 710 coupled to one or more display devices 701, such as Cathode Ray Tube (“CRT”) displays, plasma displays, Liquid Crystal Displays (“LCDs”), Light Emitting Diode (“LED”) displays, light emitting polymer displays (“LPDs”) projectors and to one or more input devices 706, such as a keyboard and a cursor pointing device. Other known configurations of a computer system may be used. Computer system 700 by itself or networked with one or more other computer systems 700 may provide an information handling/processing system.

Programmed computing device 710 may be programmed with a suitable operating system, which may include Mac OS, Java Virtual Machine, Real-Time OS Linux, Solaris, iOS, Darwin, Android Linux-based OS, Linux, OS-X, UNIX, or a Windows operating system, among other platforms, including without limitation an embedded operating system, such as VxWorks. Programmed computing device 710 includes a central processing unit (“CPU”) 704, one or more memories and/or storage devices (“memory”) 705, and one or more input/output (“I/O”) interfaces (“I/O interface”) 702. Programmed computing device 710 may optionally include an image processing unit (“IPU”) 707 coupled to CPU 704 and one or more peripheral cards 709 coupled to I/O interface 702. Along those lines, programmed computing device 710 may include graphics memory 708 coupled to optional IPU 707.

CPU 704 may be a type of microprocessor known in the art, such as available from IBM, Intel, ARM, and Advanced Micro Devices for example. CPU 704 may include one or more processing cores. Support circuits (not shown) may include busses, cache, power supplies, clock circuits, data registers, and the like.

Memory 705 may be directly coupled to CPU 704 or coupled through I/O interface 702. At least a portion of an operating system may be disposed in memory 705. Memory 705 may include one or more of the following: flash memory, random access memory, read only memory, magneto-resistive read/write memory, optical read/write memory, cache memory, magnetic read/write memory, and the like, as well as non-transitory signal-bearing media as described below. For example, memory 705 may include an SSD, which is coupled to I/O interface 702, such as through an NVMe-PCle bus, SATA bus or other bus. Moreover, one or more SSDs may be used, such as for NVMe, RAID or other multiple drive storage for example.

I/O interface 702 may include chip set chips, graphics processors, and/or daughter cards, among other known circuits. In this example, I/O interface 702 may be a Platform Controller Hub (“PCH”). I/O interface 702 may be coupled to a conventional keyboard, network, mouse, camera, microphone, display printer, and interface circuitry adapted to receive and transmit data, such as data files and the like.

Programmed computing device 710 may optionally include one or more peripheral cards 709. An example of a daughter or peripheral card may include a network interface card (“NIC”), a display interface card, a modem card, and a Universal Serial Bus (“USB”) interface card, among other known circuits. Optionally, one or more of these peripherals may be incorporated into a motherboard hosting CPU 704 and I/O interface 702. Along those lines, IPU 707 may be incorporated into CPU 704 and/or may be of a separate peripheral card.

Programmed computing device 710 may be coupled to a number of client computers, server computers, or any combination thereof via a conventional network infrastructure, such as a company's Intranet and/or the Internet, for example, allowing distributed use. Moreover, a storage device, such as an SSD for example, may be directly coupled to such a network as a network drive, without having to be directly internally or externally coupled to programmed computing device 710. However, for purposes of clarity and not limitation, it shall be assumed that an SSD is housed in programmed computing device 710.

Memory 705 may store all or portions of one or more programs or data, including variables or intermediate information during execution of instructions by CPU 704, to implement processes in accordance with one or more examples hereof to provide a program product 720. Program product 720 may be for implementing portions of process flows, as described herein. Additionally, those skilled in the art will appreciate that one or more examples hereof may be implemented in hardware, software, or a combination of hardware and software. Such implementations may include a number of processors or processor cores independently executing various programs, dedicated hardware and/or programmable hardware.

Along those lines, implementations related to use of computing device 710 for implementing techniques described herein may be performed by computing device 710 in response to CPU 704 executing one or more sequences of one or more instructions contained in main memory of memory 705. Such instructions may be read into such main memory from another machine-readable medium, such as a storage device of memory 705. Execution of the sequences of instructions contained in main memory may cause CPU 704 to perform one or more process steps described herein. In alternative implementations, hardwired circuitry may be used in place of or in combination with software instructions for such implementations. Thus, the example implementations described herein should not be considered limited to any specific combination of hardware circuitry and software, unless expressly stated herein otherwise.

One or more program(s) of program product 720, as well as documents thereof, may define functions of examples hereof and can be contained on a variety of non-transitory tangible signal-bearing media, such as computer- or machine-readable media having code, which include, but are not limited to: (i) information permanently stored on non-writable storage media (e.g., read-only memory devices within a computer such as CD-ROM or DVD-ROM disks readable by a CD-ROM drive or a DVD drive); or (ii) alterable information stored on writable storage media (e.g., floppy disks within a diskette drive or flash drive or hard-disk drive or read/writable CD or read/writable DVD).

Computer readable storage media encoded with program code may be packaged with a compatible device or provided separately from other devices. In addition, program code may be encoded and transmitted via wired optical, and/or wireless networks conforming to a variety of protocols, including the Internet, thereby allowing distribution, e.g., via Internet download. In implementations, information downloaded from the Internet and other networks may be used to provide program product 720. Such transitory tangible signal-bearing media, when carrying computer-readable instructions that direct functions hereof, represent implementations hereof.

Along those lines the term “tangible machine-readable medium” or “tangible computer-readable storage” or the like refers to any tangible medium that participates in providing data that causes a machine to operate in a specific manner. In an example implemented using computer system 700, tangible machine-readable media are involved, for example, in providing instructions to CPU 704 for execution as part of programmed product 720. Thus, a programmed computing device 710 may include programmed product 720 embodied in a tangible machine-readable medium. Such a medium may take many forms, including those describe above.

The term “transmission media”, which includes coaxial cables, conductive wire and fiber optics, including traces or wires of a bus, may be used in communication of signals, including a carrier wave or any other transmission medium from which a computer can read. Transmission media can also take the form of acoustic or light waves, such as those generated during radio-wave and infra-red data communications.

Various forms of tangible signal-bearing machine-readable media may be involved in carrying one or more sequences of one or more instructions to CPU 704 for execution. For example, instructions may initially be carried on a magnetic disk or other storage media of a remote computer. The remote computer can load the instructions into its dynamic memory and send such instructions over a transmission media using a modem. A modem local to computer system 700 can receive such instructions on such transmission media and use an infra-red transmitter to convert such instructions to an infra-red signal. An infra-red detector can receive such instructions carried in such infra-red signal and appropriate circuitry can place such instructions on a bus of computing device 710 for writing into main memory, from which CPU 704 can retrieve and execute such instructions. Instructions received by main memory may optionally be stored on a storage device either before or after execution by CPU 704.

Computer system 700 may include a communication interface as part of I/O interface 702 coupled to a bus of computing device 710. Such a communication interface may provide a two-way data communication coupling to a network link connected to a local network 722. For example, such a communication interface may be a local area network (“LAN”) card to provide a data communication connection to a compatible LAN. Wireless links may also be implemented. In any such implementation, a communication interface sends and receives electrical, electromagnetic or optical signals that carry digital and/or analog data and instructions in streams representing various types of information.

A network link to local network 722 may provide data communication through one or more networks to other data devices. For example, a network link may provide a connection through local network 722 to a host computer 724 or to data equipment operated by an Internet Service Provider (“ISP”) 726 or another Internet service provider. ISP 726 may in turn provide data communication services through a world-wide packet data communication network, the “Internet” 728. Local network 722 and the Internet 728 may both use electrical, electromagnetic or optical signals that carry analog and/or digital data streams. Data carrying signals through various networks, which carry data to and from computer system 700, are exemplary forms of carrier waves for transporting information.

Wireless circuitry of I/O interface 702 may be used to send and receive information over a wireless link or network to one or more other devices' conventional circuitry such as an antenna system, an RF transceiver, one or more amplifiers, a tuner, one or more oscillators, a digital signal processor, a CODEC chipset, memory, and the like. In some implementations, wireless circuitry may be capable of establishing and maintaining communications with other devices using one or more communication protocols, including time division multiple access (TDMA), code division multiple access (CDMA), global system for mobile communications (GSM), Enhanced Data GSM Environment (EDGE), wideband code division multiple access (W-CDMA), Long Term Evolution (LTE), LTE-Advanced, WIFI (such as IEEE 802.11a, IEEE 802.11b, IEEE 802.11g and/or IEEE 802.11n), Bluetooth, Wi-MAX, voice over Internet Protocol (VoIP), near field communication protocol (NFC), a protocol for email, instant messaging, and/or a short message service (SMS), or any other suitable communication protocol. A computing device can include wireless circuitry that can communicate over several different types of wireless networks depending on the range required for the communication. For example, a short-range wireless transceiver (e.g., Bluetooth), a medium-range wireless transceiver (e.g., WIFI), and/or a long range wireless transceiver (e.g., GSM/GPRS, UMTS, CDMA2000, EV-DO, and LTE/LTE-Advanced) can be used depending on the type of communication or the range of the communication.

Computer system 700 can send messages and receive data, including program code, through network(s) via a network link and communication interface of I/O interface 702. In the Internet example, a server 730 might transmit a requested code for an application program through Internet 728, ISP 726, local network 722 and I/O interface 702. A server/Cloud-based system 730 may include a backend application for providing one or more applications or services as described herein. Received code may be executed by processor 704 as it is received, and/or stored in a storage device, or other non-volatile storage, of memory 705 for later execution. In this manner, computer system 700 may obtain application code in the form of a carrier wave.

While the foregoing describes exemplary apparatus(es) and/or method(s), other and further examples in accordance with the one or more aspects described herein may be devised without departing from the scope hereof, which is determined by the claims that follow and equivalents thereof. Claims listing steps do not imply any order of the steps. Trademarks are the property of their respective owners.

1. A method for interprocess communication, comprising:
providing a first interprocess communication library and a second interprocess communication library each having server and client components configured for client-server communication with one another;
the first interprocess communication library and the second interprocess communication library in combination providing a universal library for direct communication between the first interprocess communication library and the second interprocess communication library;
providing a first process domain having a first function and having the first interprocess communication library;
providing a second process domain having a second function and having the second interprocess communication library;
transforming a function call for the first function to a message using a base class;
directly communicating the message from the first interprocess communication library to the second interprocess communication library;
wherein the first process domain and the second process domain do not have a shared kernel for the directly communicating of the message; and
communicating the message from the second interprocess communication library to the second function.

2. The method according to claim 1, further comprising:
obtaining the base class of the universal library from which the first interprocess communication library and the second interprocess communication library are provided; and
transforming function calls into corresponding messages using the base class.

3. The method according to claim 2, further comprising creating derived classes for each of the function calls between the first process domain and the second process domain with the base class of the universal library using an application programming interface associated therewith independently of an interprocess communication interface therebetween.

4. The method according to claim 3, wherein:
the first function is of a closed-source software; and
the second function is an open-source software.

5. The method according to claim 1, further comprising:
calling the second function of the second process domain from the first process domain; and
wherein the calling comprises:
creating a message object;
setting arguments; and
calling a send message function.

6. The method according to claim 1, further comprising:
socketing the first interprocess communication library in a first addressable location in the first process domain; and
socketing the second interprocess communication library in a second addressable location in the second process domain.

7. The method according to claim 6, wherein the first process domain is a socketed server for an operating system.

8. The method according to claim 7, wherein the first process domain comprises:
calling a server-child process domain of the first interprocess communication library;
putting the socketed server in a listening mode;
starting the second process domain; and
waiting for an indicator indicating the second process domain is connected to the server.

9. The method according to claim 8, wherein the second process domain is a socketed client for the operating system.

10. The method according to claim 9, wherein the second process domain comprises:
calling a client-child process domain of the second interprocess communication library;
connecting the socketed client to the socketed server; and
setting the indicator to indicate the socketed client is connected to the socketed server.

11. The method according to claim 10, further comprising:
creating a message action object for communication via the interprocess communication interface; and
setting a result variable.

12. The method according to claim 11, further comprising:
sending the message action object from the socketed server to the socketed client;
wherein the message action object represents the function call.

13. A system, comprising:
a memory configured to store program code; and
a processor coupled to the memory, wherein the processor, in response to executing the program code, is configured to initiate operations for implementing an interprocess communication interface, including:
providing a first interprocess communication library and a second interprocess communication library each having both server and client components configured for client-server communication with one another;
providing a first process domain having a first function and having the first interprocess communication library;
providing a second process domain having a second function and having the second interprocess communication library;
the first interprocess communication library and the second interprocess communication library in combination providing a universal library for direct communication between the first interprocess communication library and the second interprocess communication library;
transforming a function call for the first function to a message using a base class;
directly communicating the message from the first interprocess communication library to the second interprocess communication library;
wherein the first process domain and the second process domain do not have a shared kernel for the directly communicating of the message; and
communicating the message from the second interprocess communication library to the second function.

14. The system according to claim 13, wherein the operations further include:
obtaining the base class of the universal library from which of the first interprocess communication library and the second interprocess communication library are provided; and
transforming function calls into corresponding messages using the base class.

15. The system according to claim 14, wherein the operations further include creating derived classes for each of the function calls between the first process domain and the second process domain with the base class of the universal library using an application programming interface associated therewith independently of the interprocess communication interface therebetween.

16. The system according to claim 14, wherein the operations further include:
calling the second function of the second process domain from the first process domain; and
wherein the calling comprises:
creating a message object;
setting arguments; and
calling a send message function.

17. The system according to claim 14, wherein the operations further include for the first process domain:
calling a server-child process domain of the first interprocess communication library;
putting a server in a listening mode;
starting the second process domain; and
waiting for an indicator indicating the second process domain is connected to the server.

18. The system according to claim 17, wherein the operations further include for the second process domain:
calling a client-child process domain of the second interprocess communication library;
connecting a client to the server; and
setting the indicator to indicate the client is connected to the server.

19. The system according to claim 14, wherein the operations further include:
creating a message action object for communication via the interprocess communication interface; and
setting a result variable.

20. The system according to claim 19, wherein the operations further include:
sending the message action object from the server to the client;
wherein the message action object represents the function call.
